(19) United States
(12) Patent Application Publication
(10) Pub. No.: US 2024/0279823 A1
(43) Pub. Date: Aug. 22, 2024

(54) ELECTROLYTIC CELL FOR POLYMER ELECTROLYTE MEMBRANE ELECTROLYSIS AND METHOD FOR THE PRODUCTION THEREOF

(71) Applicant: Siemens Energy Global GmbH & Co. KG, München (DE)

(72) Inventors: Andre Klinger, Nürnberg (DE); Yashar Musayev, Nürnberg (DE)

(21) Appl. No.: 18/681,101

(22) PCT Filed: Jun. 8, 2022
(86) PCT No.: PCT/EP2022/065490

§ 371 Date: Feb. 5, 2024

(30) Foreign Application Priority Data
Aug. 6, 2021 (EP) 21190122.8

(51) Int. Cl. C25B 9/19; C25B 1/02; C25B 11/032; C25B 11/052; C25B 11/081; C25B 13/08

(52) U.S. Cl. CPC C25B 9/19; C25B 1/02; C25B 11/032; C25B 11/052; C25B 11/081; C25B 13/08

(57) ABSTRACT

An electrolytic cell for polymer electrolyte membrane electrolysis with a cathode half-cell and an anode half-cell is provided. The cathode half-cell and the anode half-cell being separated from one another by a polymer electrolyte membrane. The anodic half-cell has a gas diffusion layer. The gas diffusion layer is made from a fine-meshed metallic carrier material. An anodic catalyst layer with an anodic catalyst material is applied onto the polymer electrolyte membrane. The anodic catalyst layer is arranged adjacent to the gas diffusion layer, wherein a thin protective layer is applied in each case locally and selectively onto the fine-meshed carrier material in the area of the contact points between the gas diffusion layer and the adjoining anodic catalyst layer. The thin protective layer comprises iridium and/or iridium oxide so that the input of anodic catalyst material into the gas diffusion layer is inhibited.

### BACKGROUND

The invention relates to an electrolysis cell for polymer electrolyte membrane electrolysis, to a method for producing such an electrolysis cell, to the use of such an electrolysis cell and also to the use of a catalyst material.

Hydrogen can be obtained by electrolysis from deionized water. The electrochemical cell reactions that proceed are the hydrogen evolution reaction (HER) and oxygen evolution reaction (OER). In the case of acidic electrolysis, the reactions mentioned at the anode and cathode can be defined as follows:

Anode 2 H₂O→4H⁺+O₂+4e⁻ (I)

Cathode H⁺+2e⁻→H₂ (II)

In what is called polymer electrolyte membrane electrolysis (PEM electrolysis), the two part-reactions according to equations (I) and (II) are conducted spatially separately in a respective half-cell for the OER and HER. The reaction spaces are separated by means of a proton-conductive membrane, the polymer electrolyte membrane (PEM), also known by the term proton exchange membrane. The PEM ensures substantial separation of the hydrogen and oxygen product gases, electrical insulation of the electrodes, and conduction of the hydrogen ions (protons) as positively charged particles. A PEM electrolysis system typically comprises a plurality of PEM electrolysis cells, as described in EP 3 489 394 A1, for example.

A PEM electrolysis cell is described, for example, in EP 2 957 659 A1. The PEM electrolysis cell shown there comprises an electrolyte formed of a proton-conductive membrane (proton exchange membrane, PEM), on either side of which are located the electrodes, a cathode and an anode. The unit made up of membrane and electrodes is referred to as the membrane electrode assembly (MEA). A gas diffusion layer lies against each electrode. The gas diffusion layers are contacted by what are known as bipolar plates. A respective bipolar plate often at the same time forms a channel structure configured for media transport of the reactant and product streams involved. At the same time, the bipolar plates separate the individual electrolysis cells from one another, the latter being stacked to form an electrolysis stack having a multiplicity of electrolysis cells. The PEM electrolysis cell is fed with water as reactant which at the anode is electrochemically decomposed into oxygen product gas and protons H⁺. The protons H⁺ migrate through the electrolyte membrane in the direction of the cathode. They recombine on the cathode side to form hydrogen product gas H₂.

These cell reactions according to equations (I) and (II) are in equilibrium with their reverse reactions at a cell voltage of 1.48 V, taking account of the increase in entropy on transformation of the liquid water to gaseous hydrogen and oxygen. In order to achieve correspondingly high flows of product in an appropriate time (production output) and hence a flow of current, there is a need for a higher voltage, the overvoltage. PEM electrolysis is therefore conducted at a cell voltage of about 1.8-2.1 V.

A PEM electrolysis cell is also described in Kumar, S. et al., Hydrogen production by PEM water electrolysis—A review, Materials Science for Energy Technologies, 2 (3) 2019, 442-454. https://doi.org/10.1016/j.mset.2019.03.002. The PEM electrolysis cell consists, considered from the outside inward, of two bipolar plates, gas diffusion layers, catalyst layers and the proton-conductive membrane.

High oxidative potentials arise at the anode because of the evolution reaction of oxygen, and therefore high-value materials having fast passivation kinetics, for example titanium, are used for the gas diffusion layer for example. The same goes for the material choice for the anode-side catalyst material. However, even these measures cannot wholly prevent the degradation effects at the anode, but at best delay them.

In contrast, the potential is less oxidative at the cathode, and so it is possible to manufacture the gas diffusion layers there from stainless steel. However, these corrode as a result of the acidic medium of the PEM electrolysis inter alia. This corrosion process is called acid corrosion. It is not necessary here for elemental oxygen to be present, since this is already provided alone by the dissociation of the surrounding water. The metal ions at the interface of the metal surface are oxidized by the hydroxide anion to the respective hydroxide salt. This leads to degradation of the cell, which is manifested by an increase in internal resistance and by extrinsic introduction of ions into the PEM.

The prior art describes various approaches for combating the above-elucidated degradation effects at the anode and at the cathode. For example, for the anode-side catalyst it has been proposed in the catalyst layer to introduce a relatively large amount of catalytically active species into the anodic catalyst layer, i.e. to provide for a relatively high concentration of catalytically active species. This makes it possible in particular to at least temporarily compensate degradation effects of the anode with respect to the catalytic activity. In order to reduce anode-side degradation effects as a result of local electrical contact resistances and an accompanying inhomogeneous current distribution in the gas diffusion layer and catalyst layer composite system, it has been proposed inter alia to optimize the contact pressure of the gas diffusion layer against the catalyst layer. However, this always harbors the risk of perforation of the membrane electrode assembly (MEA) through an excessively high contact pressure during the joining together and axial stacking of the electrolysis cells to form an electrolysis stack and the mechanical bracing thereof with a high axial force. This leads to short circuits, as a result of which the electrolysis cell is unusable and operation of the electrolyzer is considerably jeopardized or even ruled out.

EP 2 770 564 A1 discloses a membrane electrode assembly (MEA) having a barrier layer. The barrier layer is arranged over the whole area between a catalyst layer and a gas diffusion layer, with the barrier layer comprising n electrically conductive ceramic material, inter alia iridium oxide as IrO₂ and Ir₂O₃, and a nonionic polymer binder. The barrier layer has a layer thickness from to 0.1 to 100 μm, with a correspondingly high material use and accompanying material costs in particular for the expensive iridium. As a result, a relatively large amount and concentration of catalytically active species are held available and a degradation is thereby delayed or spread out in terms of time.

The abovementioned approaches therefore do not sufficiently sustainably or reliably solve the actual problems of degradation, in particular at the anode. They are at best temporary measures for lessening and temporally spreading out the degradation effects, but fail to tackle the cause. In addition, the high material use should be noted.

Against this background, an object of the invention is that of making available an electrolysis cell with which the abovementioned problems can be reduced or preferably avoided completely, with improvements in terms of a lower material use and as homogeneous as possible a current distribution being achievable. A further object of the invention is that of specifying a method for producing such an electrolysis cell.

### SUMMARY

In one embodiment, an electrolysis cell for polymer electrolyte membrane electrolysis is provided. The electrolysis cell includes a cathodic half-cell and an anodic half-cell, wherein the cathodic half-cell and the anodic half-cell are separated from one another by means of a polymer electrolyte membrane. The anodic half-cell includes a gas diffusion layer made from a fine-mesh metallic support material and a anodic catalyst layer that is applied to the polymer electrolyte membrane and into which an anodic catalyst material has been introduced. The anodic catalyst layer is arranged adjacent to the gas diffusion layer. A thin protective layer has been applied to the fine-mesh support material locally in the region of the points of contact between the gas diffusion layer and the anodic catalyst layer adjoining same. The protective layer includes iridium and/or iridium oxide, so that the entry of anodic catalyst material into the gas diffusion layer is inhibited.

In another embodiment, a method for producing an electrolysis cell for polymer electrolyte membrane electrolysis is provided. The method includes providing a polymer electrolyte membrane, forming a cathodic half-cell adjoining the polymer electrolyte membrane, and forming an anodic half-cell adjoining the polymer electrolyte membrane. The cathodic half-cell and the anodic half-cell are arranged separated from one another by means of the polymer electrolyte membrane and a gas diffusion layer made from a fine-mesh support material is arranged in the anodic half-cell. A anodic catalyst layer, into which an anodic catalyst material is introduced, is applied to the polymer electrolyte membrane. The anodic catalyst layer is arranged adjacent to the gas diffusion layer and a thin protective layer including iridium and/or iridium oxide as layer material is applied to the fine-mesh support material locally in the region of the points of contact between the gas diffusion layer and the anodic catalyst layer adjoining same.

### DETAILED DESCRIPTION

The objects described above are achieved by the subjects of the independent claims. The dependent claims relate to preferred configurations of the solutions according to the invention.

A first aspect of the invention relates to an electrolysis cell for polymer electrolyte membrane electrolysis, having a cathodic half-cell and having an anodic half-cell, wherein the cathodic half-cell and the anodic half-cell are separated from one another by means of a polymer electrolyte membrane. The anodic half-cell has a gas diffusion layer made from a fine-mesh metallic support material and an anodic catalyst layer that is applied to the polymer electrolyte membrane and into which an anodic catalyst material has been introduced. The anodic catalyst layer is arranged adjacent to the gas diffusion layer, wherein a thin protective layer (14) has been applied to the fine-mesh support material locally in the region of the points of contact between the gas diffusion layer and the anodic catalyst layer adjoining same, and wherein the protective layer (14) comprises iridium and/or iridium oxide, so that the entry of anodic catalyst material (18) into the gas diffusion layer (9b) is inhibited.

The thus-configured electrolysis cell having a multiplicity of points of contact arranged in a grid and only locally coated achieves an effective inhibition of the entry of an anodic catalyst material into the gas diffusion layer and also provides a structure that enables a particularly homogeneous and long-term stable current distribution of the electrolysis current.

Reference is made to the introductory explanations for the terms electrolysis and polymer electrolyte membrane and also the reactions and corrosion processes and other electrochemical processes taking place. The polymer electrolyte membrane can for example be formed from a tetrafluoroethylene-based polymer having sulfonated side groups. The cathodic half-cell forms the reaction space in which the cathode reaction (s), for example according to equation (II), proceed. The anodic half-cell forms the reaction space in which the anode reaction (s), for example according to equation (I), proceed.

The invention proceeds from the finding that to date only inadequate solution approaches that failed to address the cause have been proposed for avoiding or reducing technical problems and limitations due to degradation effects and inhomogeneous current distribution in an electrolysis cell in particular on the side of the anodic half-cell. By way of example, in the case of water electrolysis in an electrolysis cell, two disadvantageous effects can be observed that are largely avoided or even overcome with the invention:

Firstly, the entry of anodic catalyst material into the gas diffusion layer accompanied by the formation of mixed phases in the gas diffusion layer. This results in a reduction in the catalytic activity of the anode and in a degradation of the electrode as a whole during operation, which is highly disadvantageous. Later reprocessing of a gas diffusion layer used over the operating life of an electrolyzer is also made more difficult.

Secondly, an increase in the local electrical contact resistance can be observed during operation. This has an essential cause in a rapidly manifesting oxidation (passivation) of the material during operation of the gas diffusion layer. The oxidation can predominantly be observed at the surface of the gas diffusion layer and adjoining current-carrying electrical contact surfaces. These local contact surfaces that are then electrically poorly conducting due to the oxidation lead to high ohmic losses in the electrolysis cell and to a necessary increase in the cell voltage at constant current density. Efficiency losses and degradation of the anode are the result here of inhomogeneous current distribution with disadvantageous local current peaks.

The fine-mesh support material is preferably configured as a uniform or regular grid, for example of expanded metal, so that a multiplicity of points of contact with the protective layer extend regularly and in a grid form across the faces of the gas diffusion layer and anodic catalyst layer that are facing each other. The regular points of contact result in the formation of correspondingly grid-regular local contact surfaces that promote good and particularly uniform contacting for improvement of the current distribution. A particularly low material use for expensive iridium and/or iridium oxide can be observed in this case.

The invention thus counters both problems with a gas diffusion layer that is advantageously configured as a diffusion barrier against the entry of anodic catalyst material and functions accordingly. The successive degradation during operation and hence the loss of anodic catalyst material is avoided by the inhibition of the entry of catalyst material into the gas diffusion layer. The catalytic activity is maintained and the gas diffusion layer is at the same time protected from degradation and can fulfill its function in an electrolyzer.

The formation of the gas diffusion layer with an advantageous action as diffusion barrier serves to suppress the movements of atoms and molecules between the adjoining materials in the anodic half-cell, in this case the inhibition of the entry of anodic catalyst material and the base material of the gas diffusion electrode. The diffusion processes that would otherwise lead over time to impurities or undesired chemical reactions, as in known concepts, are thus suppressed particularly effectively and sustainably with the invention. In particular, a barrier against the entry of anodic catalyst material into the gas diffusion layer is created.

Furthermore, the diffusion barrier simultaneously acts as a protection for the electrically conductive gas diffusion layer against oxidation and hence disadvantageous losses of electrical conductivity, as a result of which local contacts are markedly improved. The gas diffusion layer can continue to fulfill its task for electrical transport and mass transport. The current density becomes more homogeneous across the effective cell surface of the electrolysis cell, which is advantageous.

The gas diffusion layer therefore has a thin and only locally applied protective layer into which a diffusion-inhibiting layer material has been introduced.

In the context of the present invention, a layer can be understood to be a planar structure the dimensions of which in the layer plane, the length and width, are much larger than the dimension in the third dimension, the layer thickness.

The introduction of material into layers, for example diffusion-inhibiting layer material or other materials, makes it possible in a particularly simple manner to realize a predefinable distribution of the materials in the anodic half-cell. In addition, the handling of the catalyst materials can be made easier.

It is thus preferably possible that the gas diffusion layer, which is formed from a base body made from a base material, has been applied to the diffusion-inhibiting protective layer locally in areas at the points of contact. In the gas diffusion layer, therefore, the base body with the base material forms a first layer and the diffusion-inhibiting protective layer forms a second layer of the gas diffusion layer.

In one embodiment of the electrolysis cell, the fine-mesh support material is therefore configured in the form of a grid so that the points of contact with the protective layer extend regularly across the faces of the gas diffusion layer and anodic catalyst layer that are facing each other.

This provides a structured, locally coated surface on the fine-mesh support material, since the points of contact form elevations with corresponding contact surfaces coated with the protective layer.

According to one embodiment, the anodic catalyst material has been introduced into an anodic catalyst layer.

This provides an anodic catalyst layer that has been introduced into a corresponding catalyst layer provided specifically therefor. The catalyst layer can be arranged adjacent to, preferably immediately adjacent to, thus in direct contact with, the gas diffusion layer, with the anodic catalyst layer and the protective layer being in contact. The anodic catalyst layer is therefore preferably arranged immediately adjacent to the protective layer, so that areal contact is brought about.

In other words, the planar-form diffusion-inhibiting protective layer and the anodic catalyst layer can directly adjoin one another, for example be arranged directly on one another, to form an interface arranged parallel to the respective layer planes. Entry of anodic catalyst material from the anodic catalyst layer into the gas diffusion layer is hereby suppressed or at least largely avoided by the diffusion-inhibiting protective layer.

According to one embodiment, the anodic catalyst layer is arranged adjacent to, preferably directly adjacent to, thus in direct contact with, the polymer electrolyte membrane.

Accordingly, the likewise planar-form polymer electrolyte membrane and the anodic catalyst layer can directly adjoin one another, for example be arranged directly on one another, to form an interface arranged parallel to the layer planes.

If the diffusion-inhibiting protective layer of the gas diffusion layer is likewise arranged adjacent to the anodic catalyst layer, an arrangement results in which the anodic catalyst layer on one side adjoins the diffusion-inhibiting protective layer and on the opposite side adjoins the polymer electrolyte membrane.

According to one embodiment, the anodic half-cell of the electrolysis cell can have a gas diffusion layer. The gas diffusion layer can be arranged adjacent to, preferably directly adjacent to, the anodic catalyst layer.

The gas diffusion layer of the electrolysis cell serves for transporting the gaseous reaction products of the catalytic reaction (s) away from the catalyst material (s) and also for electrical contacting. It can therefore also be referred to as a current collector layer or gas diffusion electrode. The invention on the one hand achieves a particularly homogeneous current density distribution so that during operation local current peaks are avoided. On the other hand, the catalytic activity of the anodic catalyst layer is long-term stable since a degradation of the anodic half-cell is inhibited by avoiding the entry of anodic catalyst material into the gas diffusion layer.

The gas diffusion layer of the anodic half-cell comprises a porous material for ensuring sufficient gas permeability. The gas diffusion layer can for example be manufactured from titanium as base material with a porous base body, for example a titanium-based expanded metal or wire mesh, and be provided with the diffusion-inhibiting protective layer. This can increase the useful life or operating life of the gas diffusion layer and the described disadvantageous degradation effects are reduced.

In one embodiment, the protective layer has a layer thickness of about 50 nm to 200 nm, in particular of about 80 nm to 120 nm. Even low layer thicknesses of just 100 nm are sufficient to establish the diffusion-inhibiting effect. Compared to typical layer thicknesses of a catalyst layer, only very small amounts of layer material are required for the protective layer in order to form this diffusion barrier. A low layer thickness is economically advantageous since only a low material use is required for the protective layer.

In one embodiment, a catalytically active layer material has been introduced into the protective layer. This choice of material for the protective layer makes it possible to achieve not only the action as diffusion barrier with respect to the anodic catalyst material but also at the same time a catalytic action. The targeted introduction of catalyst material into the protective layer brings about a saturation with catalyst material at the interface between the gas diffusion layer and the anodic catalyst layer. This saturation results in the inhibition of further entry of anodic catalyst material into the gas diffusion layer; the kinetics for the further uptake of anodic catalyst material are virtually suppressed.

In one embodiment, the catalytic layer material introduced is anodic catalyst material. The similarity of the material choice means that problems of coordination are avoided. In particular, a catalytic action is long-term stable with a simultaneous effective action against migration by diffusion of anodic catalyst material from the anodic catalyst layer into the gas diffusion layer. The anodic catalyst layer does not degrade. Moreover, the catalytic layer material in the protective layer already brings about a passivation; an oxidative attack on the base material of the gas diffusion layer is consequently suppressed.

The mechanism of action specifically exploited here by this advantageous configuration is such that, as a result of applying a tight protective layer to the anode-side base material of the gas diffusion layer, no less-conductive oxide layer can form any longer from oxygen and the base material since the oxygen required for the passivation of the base material is no longer available. The role of the passive layer is now taken care of by the catalytic layer material. The electrons released in the anodic catalyst layer or at the active center of the anodic catalyst can be transferred without increased resistance into the bulk material via the protective layer. This results in the local contacts being considerably improved and hence the current density being more homogeneous across the cell surface.

In one embodiment, the anodic half-cell has iridium and/or iridium oxide or mixtures thereof as anodic catalyst material. Due to the high oxidation and solution stability, iridium or iridium oxide is particularly advantageous as catalytically active species when choosing the anode-side catalyst material.

In one embodiment, the anodic half-cell has a gas diffusion layer formed from titanium as base material. Preference is given here to using a configuration as relatively fine-mesh titanium material as base material for the gas diffusion layer, for example titanium nonwovens, titanium foams, titanium weave, titanium-based expanded metals or combinations thereof. As a result of this, the local points of contact with the electrode are also increased and the electrical resistance in the contact surface becomes particularly uniform. The term “grid” in the present context denotes a fine-mesh lattice. The support materials mentioned feature a high corrosion resistance. The terms “grid” and “weave” describe an oriented structure, the term “nonwoven” an unoriented structure.

The diffusion-inhibiting and catalytically acting layer material of iridium or iridium oxide can be applied to the titanium base material or support material of the gas diffusion layer. This advantageously enables a particularly uniform distribution of the layer material. In addition, the layer material can be provided with the largest possible surface area so that the catalytic action and passivation action can be improved with the same amount of layer material, with a very low material use being required as a result of the low layer thicknesses of about 100 nm.

In other words, an advantage of a base body or support material for the gas diffusion layer is that a higher specific surface area can be generated, as a result of which the activity of the corresponding catalyst material correspondingly rises and also the resulting passivation properties, which are of particular advantage here. A further advantage is the particularly uniform points of contact formed by the higher surface area, which result in an improvement in the contact resistance and the transverse conductivity. The anodic half-cell preferably has a gas diffusion layer formed from titanium as base material and made from a fine-mesh support material. This can be an expanded metal having a multiplicity of corresponding regularly arranged elevations at the points of contact so that regular contact surfaces are formed that are provided locally with a thin protective layer of iridium and/or iridium oxide.

In order to reduce corrosion, the gas diffusion layer is typically produced from a material on the surface of which a passivation layer rapidly forms, as is the case for titanium. However, as a result of the protective layer, in the present case the passivation is not brought about by the titanium itself but rather by the iridium, which is very advantageous. Because of the iridium in the protective layer, the latter acts as catalyst and diffusion barrier. Furthermore, the gas diffusion layer is correspondingly configured to be electrically conductive and porous for the fluid transport.

A channel structure can optionally be arranged adjacent to, preferably directly adjacent to, the gas diffusion layer. The channel structure serves to collect and discharge the gaseous reaction product of the electrolysis in the anodic half-cell, thus for example oxygen according to equation (I). The channel structure can for example be in the form of a bipolar plate. Bipolar plates enable the stacking of multiple electrolysis cells to form an electrolysis cell module, in that they electrically conductively connect the anode of one electrolysis cell with the cathode of an adjacent electrolysis cell. In addition, the bipolar plate enables gas separation between adjoining electrolysis cells.

A further aspect of the invention relates to a method for producing an electrolysis cell for polymer electrolyte membrane electrolysis. The method comprises: providing a polymer electrolyte membrane, forming a cathodic half-cell adjoining the polymer electrolyte membrane, and forming an anodic half-cell adjoining the polymer electrolyte membrane, wherein the cathodic half-cell and the anodic half-cell are arranged separated from one another by means of the polymer electrolyte membrane and a gas diffusion layer made from a fine-mesh support material is arranged in the anodic half-cell, wherein an anodic catalyst layer, into which an anodic catalyst material is introduced, is applied to the polymer electrolyte membrane, wherein the anodic catalyst layer is arranged adjacent to the gas diffusion layer, and wherein a thin protective layer comprising iridium and/or iridium oxide as layer material is applied to the fine-mesh support material locally in the region of the points of contact between the gas diffusion layer and the anodic catalyst layer adjoining same.

The method can be used to produce an above-described electrolysis cell for polymer electrolyte membrane electrolysis. Reference is accordingly made to the above elucidations and advantages of these electrolysis cells.

With the thin and locally applied protective layer comprising iridium and/or iridium oxide as layer material, a diffusion-inhibiting layer material is at the same time introduced into the gas diffusion layer in order to counteract or avoid a rapid degradation of the anodic catalyst material.

According to one embodiment, anodic catalyst material is introduced into an anodic catalyst layer. A support material, onto which the anodic catalyst material as catalytically active species is applied in a coating process, can also be used to produce the anodic catalyst layer.

In one embodiment, the anodic catalyst layer is arranged adjacent to the protective layer. Preference is given here to the immediately adjacent arrangement of the anodic catalyst layer and protective layer of the gas diffusion layer, so that they form a common interface.

In one embodiment, the protective layer is applied by means of plasma vapor deposition, plasma-assisted chemical vapor deposition (PACVD), atomic layer deposition or pulsed laser deposition (PLD) locally in the region of the points of contact on the fine-mesh support material. The support material is provided by a base material of the gas diffusion layer, in particular titanium. This is configured correspondingly in design, for the intended use as part of the anodic half-cell, for electrical contacting and homogeneous current conduction and for fluid transport. In particular, plasma-assisted chemical vapor deposition (PACVD) is especially advantageously usable for a gas diffusion layer having a fine-mesh structure, for example titanium metal grids or nonwovens, of the gas diffusion plies.

According to one embodiment, a layer thickness of about 50 nm to 200 nm, in particular of about 80 nm to 120 nm, is provided for the protective layer.

The desired effect as protection of the gas diffusion layer from degradation effects and uniform electrical contacting and homogeneous current density distribution is achievable even with the provision of a very thin layer thickness for the protective layer. The material use and the chosen coating process are highly favorable from economic perspectives as a result of the local-grid-form application to the elevations in a thin layer with layer thicknesses in the nanometer range. A full-area coating of the contact surface between the gas diffusion layer and the catalyst layer is not necessary. Application by means of chemical vapor deposition may for instance be preferred for porous structures and support materials, while application by means of physical vapor deposition may be preferred for non-porous structures. Both chemical vapor deposition and in particular physical vapor deposition advantageously enable the production of very thin layers with a layer thickness in the region of a few nanometers to a few micrometers. As a result, material for the diffusion-inhibiting layer material, preferably iridium, can be saved when forming the protective layer.

In the present context, the term “apply to” does not necessarily denote a specific spatial arrangement in the sense of “above”. The intention is instead to express that the mentioned layers are arranged adjacent to one another. The sequence of the method steps can also be reversed or modified, i.e. the anodic half-cell can alternatively be formed starting from the gas diffusion layer or the channel structure. As a further alternative, one of the middle layers, for example the gas diffusion layer or the anodic catalyst layer, may also be chosen as the starting point, to either side of which the respectively adjoining layers are applied.

The cathodic half-cell can be constructed in an analogous fashion, i.e. a catalytic layer for catalysis of the cathode reaction, for example according to equation (II), can be applied to the lateral face of the polymer electrolyte membrane that is opposite to the anodic catalyst layer, followed by a gas diffusion layer, optionally followed by a channel structure, for example in the form of a bipolar plate. The materials used for this can preferably be adapted to the conditions prevailing in the cathodic half-cell, for example with respect to the demands for corrosion resistance thereof.

A further aspect of the invention relates to the use of an electrolysis cell for the electrolytic generation of hydrogen.

The reactions according to the equations (I) and (II) can thus advantageously be conducted in the cathodic or anodic half-cell when electric current flows through the electrolysis cell.

A further aspect of the invention relates to the use of a catalyst material as diffusion-inhibiting layer material in a gas diffusion layer of an anodic half-cell of an electrolysis cell.

The catalyst material can for example be the anodic catalyst material described above, and so reference is made to the elucidations and advantages relating thereto. The material of choice is preferably iridium and/or iridium oxide. A proportion of iridium, introduced in a grid-form structure or applied to the support material in a controlled and local manner, in the protective layer of the gas diffusion electrode inhibits the entry and hence loss of further catalyst material from the anodic catalyst layer into the gas diffusion layer. Iridium as catalyst material is therefore a particularly advantageous use as diffusion-inhibiting layer material and at the same time promotes homogeneous current distribution.

The use of iridium and/or iridium oxide as diffusion-inhibiting layer material is preferred in particular, specifically applied only locally in the region of the points of contact between a gas diffusion layer formed from a fine-mesh support material and an anodic catalyst layer adjoining same of an anodic half-cell of an electrolysis cell. A multiplicity of local points of contact is formed for example by the planar elevations and surfaces of an expanded metal or similar open-pored metal structures having elevations protruding from the surface and forming a respective contact surface.

### BRIEF DESCRIPTION OF THE FIGURES

The invention is elucidated on the basis of preferred embodiments hereinafter by way of example and with reference to the appended figures, where the features presented hereinafter can constitute an aspect of the invention both taken alone and in various combinations with one another. In the figures:

FIG. 1 shows a schematic illustration of an electrolysis cell for polymer electrolyte membrane electrolysis according to the prior art;

FIG. 2 shows a schematic illustration of an exemplary electrolysis cell;

FIG. 3 shows an anodic half-cell with a detail of the exemplary gas diffusion layer in schematic illustration, and

FIG. 4 shows a flow diagram of an exemplary method according to the invention.

### DETAILED DESCRIPTION OF THE FIGURES

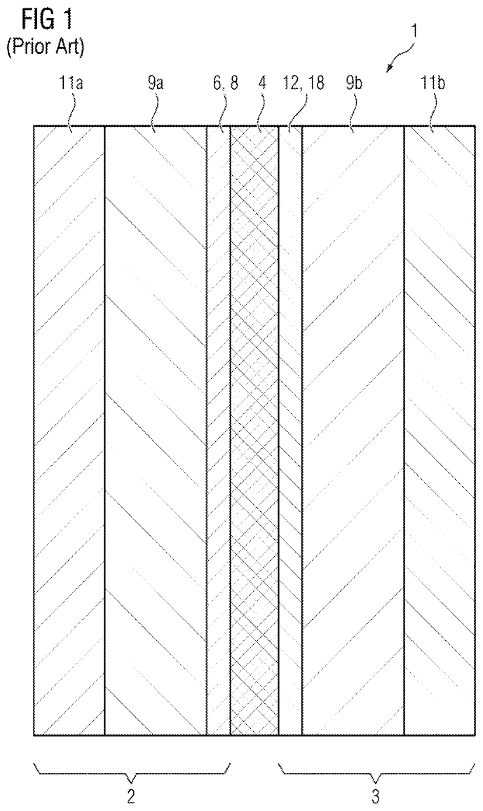

FIG. 1 shows an electrolysis cell 1 for polymer electrolyte membrane electrolysis according to the prior art in a schematic illustration. The electrolysis cell 1 serves for the electrolytic generation of hydrogen.

The electrolysis cell 1 has a polymer electrolyte membrane 4. Arranged on one side of the polymer electrolyte membrane 4, on the left in the illustration according to FIG. 1, is the cathodic half-cell 2 of the electrolysis cell, and arranged on the other side of the polymer electrolyte membrane 4, on the right in the illustration according to FIG. 1, is the anodic half-cell 3 of the electrolysis cell 1.

The anodic half-cell 3 comprises an anodic catalyst layer 12 arranged directly adjacent to the polymer electrolyte membrane 4, a gas diffusion layer 9b arranged directly adjacent to the anodic catalyst layer 12 and a channel structure 11b arranged directly adjacent to the gas diffusion layer 9b. The anodic catalyst layer 12 comprises an anodic catalyst material 18 and catalyzes the anode reaction according to equation (I). The anodic catalyst material 18 is iridium or iridium oxide chosen as catalytically active species, which has been introduced into the anodic catalyst layer. Iridium or iridium oxide has a high oxidation and solution stability and is therefore well suited as anodic catalyst material. In order to reduce corrosion, the gas diffusion layer 9b is produced from a material on the surface of which a passivation layer rapidly forms, for example from titanium. As a result of the passivation of the titanium, titanium dioxide is formed, which has a lower conductivity than titanium. The channel structure 11b is in the form of a bipolar plate, so that stacking of multiple electrolysis cells 1 is made possible.

The cathodic half-cell 2 comprises a cathodic catalyst layer 8 having a cathodic catalyst material 6, which is arranged directly adjacent to the polymer electrolyte membrane 4. The cathodic catalyst material 6 is formed for the catalysis of a reduction of hydrogen ions, in particular according to equation (II), to give molecular hydrogen. A gas diffusion layer 9a is also arranged on the cathodic catalyst layer 8. In contrast to the gas diffusion layer 9b of the anodic half-cell 3, the gas diffusion layer 9a of the cathodic half-cell 2 is manufactured from stainless steel. This is possible on account of the lower oxidation potential in the cathodic half-cell 2 compared to the anodic half-cell 3, and reduces the costs of the electrolysis cell 2. Likewise arranged immediately adjacent to the gas diffusion layer 9a is a channel structure 11a which, analogously to the anodic half-cell 3, is in the form of a bipolar plate.

A disadvantage with this electrolysis cell 1 known from the prior art is, as elucidated at the outset, generally the corrosion susceptibility of the materials. Especially in the anodic half-cell 3, considerable degradation effects can be observed that disadvantageously impair the service life of the electrolysis cell 1.

In this case, the entry of anodic catalyst material 18 into the gas diffusion layer 9b with the accompanying formation of mixed phases in the gas diffusion layer 9b can firstly be mentioned. This leads to a reduction in the catalytic activity of the anode and to a degradation of the electrode as a whole during operation, which is highly disadvantageous. Later reprocessing of a gas diffusion layer used over the operating life of an electrolyzer is also made more difficult. Especially as a result of the introduction of iridium or iridium oxide as anodic catalyst material 18 into the anodic catalyst layer 12, the formation of iridium phases at the interface with the immediately adjacent titanium gas diffusion layer 9b can be observed. The consequence is an associated reduction in the catalytic activity of the anodic half-cell 3 as a result of loss of the catalytically active species in the anodic catalyst layer.

Furthermore, an increase in the local electrical contact resistance can be observed during operation. This has an essential cause in a rapidly manifesting oxidation (passivation) of the titanium during operation of the gas diffusion layer 9b. The oxidation can predominantly be observed at the surface of the gas diffusion layer 9b and adjoining current-carrying electrical contact surfaces. These local contact surfaces that are then electrically poorly conducting due to the oxidation lead to high ohmic losses in the electrolysis cell and to a necessary increase in the cell voltage at constant current density. Efficiency losses and degradation of the anode are the result here of inhomogeneous current distribution with disadvantageous local current peaks.

Effects that are disadvantageous, particularly with regard to the acid corrosion promoted by elemental oxygen, can also be observed on the side of the cathodic half-cell 2, but these are not discussed in more detail here.

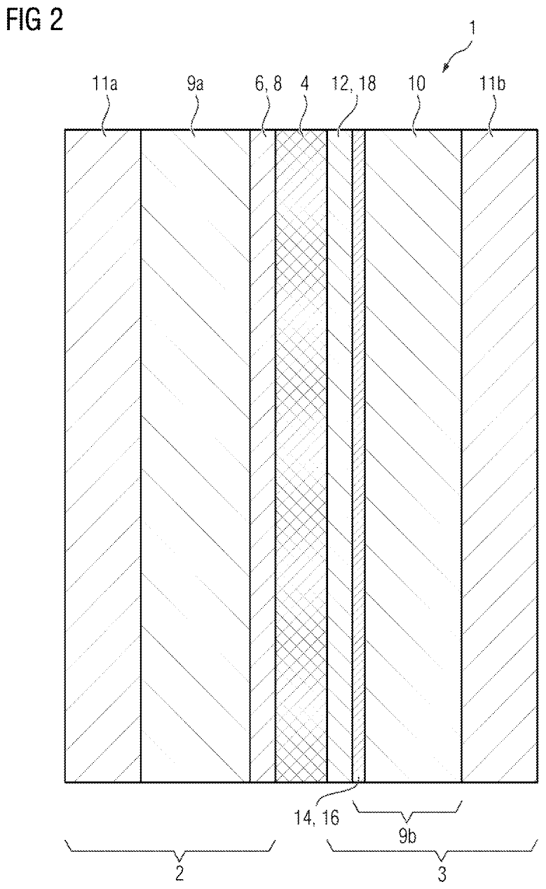

To overcome these disadvantages at the anodic half-cell 3, it is proposed to form the gas diffusion layer 9b in the anodic half-cell 3 in such a way that the disadvantageous and, during operation, continuous entry of the anodic catalyst material 18 into the gas diffusion layer 9b is inhibited or in the best case even suppressed. To this end, the gas diffusion layer 9b has a protective layer 14 into which a diffusion-inhibiting layer material 16 has been introduced. Such an electrolysis cell 1 that is advantageously modified and further developed is shown schematically and by way of example in FIG. 2.

The cathodic half-cell 2 of the exemplary embodiment of an electrolysis cell 1 shown in FIG. 2 is constructed analogously to the electrolysis cell according to FIG. 1, meaning that reference can be made to the statements relating thereto.

The anodic half-cell 3 has, also in analogy to the electrolysis cell according to FIG. 1, a gas diffusion layer 9b and a channel structure 11b. An anodic catalyst layer 12 having an anodic catalyst material 18 is likewise arranged directly adjacent to the polymer electrolyte membrane 4, with the anodic catalyst material 18 being formed for the catalysis of oxygen (OER), in particular according to equation (I), to give molecular oxygen, which is conducted away out from the anodic half-cell 3 through the channel structure 11b and further processed.

In contrast to the electrolysis cell 2 according to FIG. 2, the gas diffusion layer 9b additionally has a protective layer 14, into which the diffusion-inhibiting layer material 16 has been introduced. The layer material 16 is made from iridium and/or iridium oxide or a mixture thereof, with the layer material 16 having been correspondingly introduced into the gas diffusion layer 9b. This is achieved, for example, by the gas diffusion layer 9b having a support material 10 that contains titanium or is made from titanium. The support material 10 at the same time forms the base body of the gas diffusion layer 9b on which the iridium-comprising or iridium-based layer material 16 has been applied by means of a suitable coating method. The anodic catalyst material 18 has been introduced into the anodic catalyst layer 12 that on one side immediately adjacently adjoins the protective layer 14 of the gas diffusion layer 9b. On the other side, the anodic catalyst layer 12 immediately adjoins the polymer electrolyte membrane 4. The diffusion-inhibiting protective layer 14 of the gas diffusion layer 9b is implemented as an iridium coating on the support material 10, in the example titanium, and has a very low layer thickness of only around 100 nm.

This is particularly advantageous for the low material requirement for iridium for the protective layer 14. At the same time, the entry of anodic catalyst material 18 into the gas diffusion layer 9b is very effectively inhibited. The coating, implemented as a protective layer 14 comprising iridium, of the titanium base body additionally fulfills the task of passivation and further leads to a more homogeneous current density distribution across the cell surface of the anodic half-cell 3 on account of uniform and long-term stable electrical contacting. As a result of the thin protective layer 14 of iridium and/or iridium oxide, a passivation layer is provided without a noteworthy increase in the electrical resistance. The electrons can be transferred via the protective layer 14 into the titanium bulk material of the gas diffusion layer 9b.

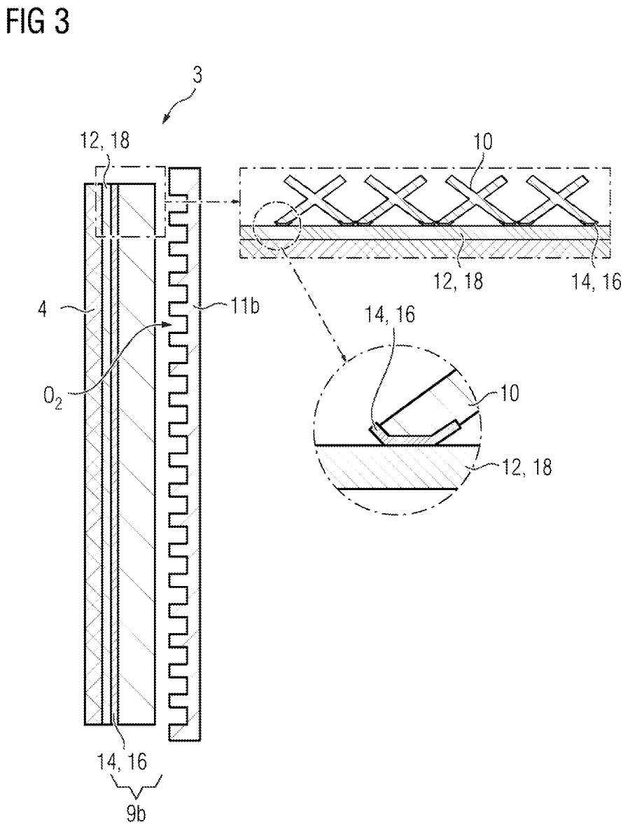

FIG. 3 shows an anodic half-cell 3 with a detail of the exemplary gas diffusion layer 9b in schematic and enlarged illustration. The support material 10 used is titanium, which for example can be implemented as a layering of expanded metal or a spiral mesh or formed from other porous and simultaneously mechanically stable structures. Also possible, for example, are thus nonwovens that are for example arranged in layered or ply form on a wire mesh, metal foam or a sintered metal plate.

For the choice of material and the structure of the support material 10, attention should be paid that the gas diffusion layer 9b ensures an optimal distribution of the water and also transport of the product gases away. The present gas diffusion layer 9b additionally serves as a current distributor of the anodic half-cell 3. For these reasons, the gas diffusion layer 9b is formed from an electrically conductive porous material, by way of example titanium here, which has been introduced into the gas diffusion layer 9b in a corresponding structure and arrangement. In addition, in the exemplary embodiment shown, the gas diffusion layer 9b compensates component tolerances, in particular those of the adjacent channel structure 11b, since a certain spring elasticity against mechanical forces is provided by the porosity and the choice of material.

A thin protective layer 14 of iridium as layer material 16 has been applied to the titanium-based support material 10 that in the detail of the anodic half-cell 3 of FIG. 3 is implemented in grid form. The protective layer 14 immediately adjoins the anodic catalyst layer 12, which likewise comprises iridium. In further detail enlargement, in FIG. 3 a region between the anodic catalyst layer 12 and the gas diffusion layer 9b is shown in somewhat more detail. Only in the region of the points of contact between the gas diffusion layer 9b and the adjoining anodic catalyst layer 12 is a thin protective layer 14 comprising iridium and/or iridium oxide locally and selectively additionally applied to the support material 10 of the gas diffusion layer 9b. This protective layer 14 acts both as a diffusion barrier against the entry of anodic catalyst material 18 from the catalyst layer 12 and as a passivation layer for the gas diffusion layer 9b. As a result of the advantageous material choice of iridium and/or iridium oxide, the protective layer 14 also at the same time acts as a catalytically active layer for a material reserve. The fine-mesh support material (10) is configured in the form of a grid as a uniform grid, for example of expanded metal, so that a multiplicity of the points of contact with the protective layer (14) extend regularly and in the form of a grid across the faces of the gas diffusion layer (9b) and anodic catalyst layer (12) that are facing each other. As a result of the regular points of contact, local contact surfaces are formed that promote a good and uniform contacting for an improvement in the current distribution with a low material use of iridium and/or iridium oxide. Only the contact surfaces are coated and provided with the protective layer (14).

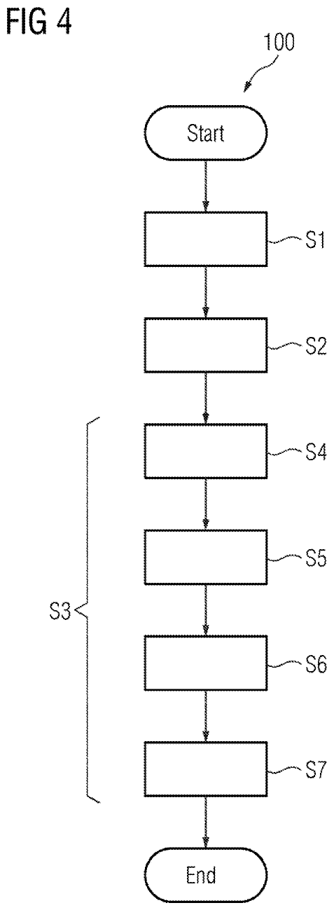

FIG. 4 shows a simplified flow diagram of an exemplary method 100 for producing an electrolysis cell 1, for example the electrolysis cell 1 shown in FIG. 2. After the start of method 100, a polymer electrolyte membrane 4 is provided in step S1. A cathodic half-cell 2 adjoining the polymer electrolyte membrane 4 is then formed in step S2. For this, the cathodic catalyst layer 12, the gas diffusion layer 9a and the channel structure 11a can be correspondingly arranged on one another, for example deposited on one another.

In step S3, the anodic half-cell 3 is formed, likewise adjoining the polymer electrolyte membrane 4 but on the opposite side and separated from the cathodic half-cell 2. The anodic catalyst material 18, which is formed for the catalysis of protons and molecular oxygen, is arranged in the anodic catalyst layer 12 of the cathodic half-cell 3. Steps S2 and S3 can also be conducted in parallel in terms of time or in the reverse sequence. The gas diffusion layer 9b is also arranged in the anodic half-cell 3 in step S3, with the gas diffusion layer 9b being formed for inhibition of the entry or migration of anodic catalyst material 18 into the gas diffusion layer 9b.

Step S3 in general comprises further substeps S4 to S7, that is to say the anodic half-cell 2 is formed in the exemplary embodiment by means of steps S4 to S7. These substeps are adapted to the respective production process in terms of sequence. Individual steps can also be conducted in parallel in terms of time or in the reverse sequence:

In step S4, a protective layer 14 having a diffusion-inhibiting layer material 16 is first introduced into the gas diffusion layer 9b. To this end, the protective layer 14 is formed on the titanium-based support material (10) in a step S5 by means of suitable coating method, such as for example plasma vapor deposition (PVD), plasma-assisted chemical vapor deposition (PACVD), atomic layer deposition (ALD) or pulsed laser deposition (PLD). In particular, the plasma-assisted chemical vapor deposition (PACVD) method is especially advantageously usable for the requirements for a gas diffusion layer having a fine-mesh structure, for example titanium metal grids or titanium expanded metal or nonwovens, which has been arranged to some extent in multiple gas diffusion plies. The thin protective layer (14) of iridium and/or iridium oxide has been applied to the fine-mesh support material (10), made of titanium, only locally in the region of the points of contact between the gas diffusion layer (9b) and the anodic catalyst layer (12) adjoining same, as described in detail and illustrated in the enlarged detail in FIG. 3. The protective layer (14) of iridium and/or iridium oxide prevents an entry of anodic catalyst material (18) into the gas diffusion layer (9b), so that degradation effects are inhibited.

Irrespective of the coating process chosen according to the requirement, in the method in a step S5 the layer thickness is monitored already during the coating process until the desired layer thickness of typically only around 100 nm and less has been achieved. In a step S6, the anodic catalyst layer 12 is arranged immediately adjacent to the protective layer 14, so that these layers are adjoining one another. As a result, a common interface or contact surface between the anodic catalyst layer 12 and protective layer 14 is formed. The gas diffusion layer 9b having the protective layer 14 is thus applied to the anodic catalyst layer 7, before a channel structure 11b in the form of a bipolar plate is applied to the gas diffusion layer 9b in step S7.

It should be noted that the cathodic half-cell 2 can also be formed starting from the channel structure 11a. That is to say, the channel structure 11a can be chosen as the starting point, onto which first the gas diffusion layer 9a, then the cathodic catalyst layer 8 and lastly the polymer electrolyte membrane 4 are applied. A corresponding procedure is possible for the anodic half-cell 3. Consequently, the layers and structures of the electrolysis cell 1 can alternatively also be constructed starting from the channel structure 11a of the cathodic half-cell 2 or starting from the channel structure 11b of the anodic half-cell 3.

It will be appreciated that other embodiments can be used and structural or logical modifications can be made without departing from the scope of protection of the present invention. Thus, features of the exemplary embodiment described herein can be combined with one another unless specifically stated otherwise. The description of the exemplary embodiment should accordingly not be interpreted in a limiting sense, and the scope of protection of the present invention is defined by the appended claims.

The expression “and/or” used herein means, when used in a series of two or more elements, that each of the elements stated can be used alone or any combination of two or more of the listed elements can be used.

1. An electrolysis cell for polymer electrolyte membrane electrolysis, having a cathodic half-cell and an anodic half-cell, wherein the cathodic half-cell and the anodic half-cell are separated from one another by means of a polymer electrolyte membrane, the anodic half-cell comprising:
a gas diffusion layer made from a fine-mesh metallic support material; and
a anodic catalyst layer that is applied to the polymer electrolyte membrane and into which an anodic catalyst material has been introduced, wherein the anodic catalyst layer is arranged adjacent to the gas diffusion layer,
wherein a thin protective layer has been applied to the fine-mesh support material locally in the region of the points of contact between the gas diffusion layer and the anodic catalyst layer adjoining same, and
wherein the protective layer comprises iridium and/or iridium oxide, so that the entry of anodic catalyst material into the gas diffusion layer is inhibited.

2. The electrolysis cell as claimed in claim 1, in which the fine-mesh support material is configured in the form of a grid so that the points of contact with the protective layer extend regularly across the faces of the gas diffusion layer and anodic catalyst layer that are facing each other.

3. The electrolysis cell as claimed in claim 1, wherein the protective layer has a layer thickness of 50 nm to 200 nm.

4. The electrolysis cell as claimed in claim 1, wherein the protective layer has a layer thickness of 80 nm to 120 nm.

5. The electrolysis cell as claimed in claim 1, wherein the anodic half-cell further comprises iridium and/or iridium oxide or mixtures thereof as anodic catalyst material.

6. The electrolysis cell as claimed in claim 1, the anodic half-cell cell further comprises a gas diffusion layer formed from titanium as base material, wherein the fine-mesh support material is formed.

7. providing a polymer electrolyte membrane;
forming a cathodic half-cell adjoining the polymer electrolyte membrane; and
forming an anodic half-cell adjoining the polymer electrolyte membrane, wherein the cathodic half-cell and the anodic half-cell are arranged separated from one another by means of the polymer electrolyte membrane and a gas diffusion layer made from a fine-mesh support material is arranged in the anodic half-cell, wherein an anodic catalyst layer, into which an anodic catalyst material is introduced, is applied to the polymer electrolyte membrane, wherein the anodic catalyst layer is arranged adjacent to the gas diffusion layer, and wherein a thin protective layer comprising iridium and/or iridium oxide as layer material is applied to the fine-mesh support material locally in the region of the points of contact between the gas diffusion layer and the anodic catalyst layer adjoining same.

8. The method as claimed in claim 7, in which the thin protective layer is applied by means of plasma vapor deposition (PVD), plasma-assisted chemical vapor deposition (PACVD) or pulsed laser deposition (PLD) locally in the region of the points of contact on the fine-mesh support material.

9. The method as claimed in claim 7, in which, for the protective layer, the layer material is applied with a layer thickness of 50 nm to 200 nm.

10. The method as claimed in claim 7, in which, for the protective layer, the layer material is applied with a layer thickness of 80 nm to 200 nm.

11. The electrolysis cell as claimed in claim 1, wherein the electrolysis cell generates hydrogen.

12. (canceled)
